(19) United States
(12) Patent Application Publication
(10) Pub. No.: US 2022/0221374 A1
(43) Pub. Date: Jul. 14, 2022

(54) HYBRID VIBRATION-SOUND ACOUSTIC PROFILING USING A SIAMESE NETWORK TO DETECT LOOSE PARTS

(71) Applicant: Kyndryl, Inc., New York, NY (US)

(72) Inventors: Seng Chai Gan, Ashburn, VA (US); Shikhar Kwatra, San Jose, CA (US); Abhishek Malvankar, White Plains, NY (US); Vijay Ekambaram, Chennai, IN (US)

(21) Appl. No.: 17/146,556

(22) Filed: Jan. 12, 2021

(51) Int. Cl. G01M 13/028; G06N 3/04; G06N 3/08; G06F 1/28

(52) U.S. Cl. CPC G01M 13/028; G06F 1/28; G06N 3/08; G06N 3/04

(57) ABSTRACT

According to one embodiment, a method, computer system, and computer program product for detecting one or more loose or malfunctioning components within a machine is provided. The present invention may include measuring, by one or more sensors, one or more vibration signals and one or more acoustic signals of the machine; determining one or more joint signals, wherein the one or more joint signals comprise one or more relationships between the one or more vibration signals and the one or more acoustic signals; and responsive to one or more new signals deviating from the one or more vibration signals, one or more acoustic signals, and/or one or more joint signals by an amount exceeding at least one threshold, triggering one or more ameliorative actions.

### BACKGROUND

The present invention relates, generally, to the field of computing, and more particularly to fault detection.

The field of fault detection is concerned with monitoring a system to determine when a fault has occurred. The operation of machines necessarily comes with the risk of malfunction damage, or degradation, which may, if left unresolved, result in increased wear on the machine, increased risk of injury or death to those nearby, and increased risk of damage to or destruction of the machine. As machines grow ever more complex and automated, it becomes more likely that human operators will not be present to detect faults, and more costly if faults are not detected and addressed in time. As computing power improves in cost and accessibility, it becomes more and more necessary to find ways to employ intelligent software solutions to remotely monitor machines for anomalous operation that may indicate faults.

### SUMMARY

According to one embodiment, a method, computer system, and computer program product for detecting one or more loose or malfunctioning components within a machine is provided. The present invention may include measuring, by one or more sensors, one or more vibration signals and one or more acoustic signals of the machine; determining one or more joint signals, wherein the one or more joint signals comprise one or more relationships between the one or more vibration signals and the one or more acoustic signals; and responsive to one or more new signals deviating from the one or more vibration signals, one or more acoustic signals, and/or one or more joint signals by an amount exceeding at least one threshold, triggering one or more ameliorative actions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a hybrid anomaly detection process according to at least one embodiment;

FIG. 3 is an operational flowchart illustrating a baseline acoustic profile modelling process according to at least one embodiment;

FIG. 4 is an operational flowchart illustrating a baseline vibration profile modelling process according to at least one embodiment;

FIG. 5 is an operational flowchart illustrating a baseline joint acoustic and vibration profile modelling process according to at least one embodiment;

FIG. 6 is an operational flowchart illustrating a method of learning a joint embedding between acoustic and vibration embeddings according to at least one embodiment;

FIG. 7 is an operational flowchart illustrating an implementation of a hybrid anomaly detection process according to at least one embodiment;

FIG. 8 is a diagram illustrating an exemplary hardware environment of an implementation of a hybrid anomaly detection process according to at least one embodiment;

FIG. 9 is a block diagram of internal and external components of computers and servers depicted in FIG. 1 according to at least one embodiment;

FIG. 10 depicts a cloud computing environment according to an embodiment of the present invention; and

FIG. 11 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to fault detection. The following described exemplary embodiments provide a system, method, and program product to, among other things, utilize a siamese neural network to model the relationship between acoustic signals and vibrational signals produced by a machine as joint signals, and identify faults via outliers from the acoustic signals, vibrational signals, and joint signals. Therefore, the present embodiment has the capacity to improve the technical field of fault detection by profiling all possible sound and vibration clusters, individually as well as jointly, and identifying outliers within any three of the acoustic signals, vibrational signals, and joint signals; such a system provides the advantage that the system can identify not only when an acoustic signal is anomalous or a vibrational signal is anomalous, but can also identify when an acoustic signal does not correspond with a vibrational signal in the expected way, even if the component acoustic signal and vibrational signal are otherwise non-anomalous. In this way, the system is capable of greater accuracy in identifying anomalies that indicate the presence of a loose or malfunctioning part.

As previously described, the field of fault detection is concerned with monitoring a system to determine when a fault has occurred. The operation of machines necessarily comes with the risk of malfunction damage, or degradation, which may, if left unresolved, result in increased wear on the machine, increased risk of injury or death to those nearby, and increased risk of damage to or destruction of the machine. As machines grow ever more complex and automated, it becomes more likely that human operators will not be present to detect faults, and more costly if faults are not detected and addressed in time. Furthermore, in a noisy environment such as a factory, or underwater, it may be impossible for the human ear to isolate and detect the sound of loose or malfunctioning components. As computing power improves in cost and accessibility, it becomes more and more necessary to find ways to employ the power of intelligent software solutions to remotely monitor machines for anomalous operation that may indicate faults.

Some attempts to address the issue of detecting loose or faulty components within machines employ specialized systems that are limited to operation within certain narrow contexts, such as detecting loose parts within a fluid flow path; others induce vibration to detect loose parts. Some monitor vibration and sound, but do not leverage the relationship between them to identify anomalous readings detectable from the interaction between the two measurements; such systems may be able to identify anomalies in the vibrations or sounds, but are incapable of identifying anomalies where, for instance, an acoustic signal and a vibration signal are not individually anomalous, but are no longer coupled to each other as they usually are. Other attempts to address loose part detection utilize template or standard profiles to establish normal operation baselines, which are not tailored to quirks of the machine's environment or operational characteristics and may result in false or inaccurate detection of anomalous readings. As such, it may be advantageous to, among other things, implement a system that utilizes a vibrational sensor and an acoustic sensor and can be deployed to monitor machines in a variety of environments, including but not limited to fluid flow paths, underwater, in the sky, et cetera, at any distance from the machine where vibrations and acoustic signals can still be recorded, and where additional sensors, vibration generating capabilities, or additional specialized hardware are not required. It may further be advantageous to, among other things, implement a system that identifies the relationship between acoustic signals and vibration signals and models that relationship as a joint signal from which anomalies may be identified, and which utilizes machine learning techniques to establish baseline acoustic and vibrational profiles that are tailored to the machine and its environment, thereby creating a system which is versatile, easy to use, and accurate.

According to at least one embodiment, the invention may be a system that uses one or more vibrational sensors and one or more acoustic sensors to monitor audio signals and vibrational signals from a machine, and which may utilize a Siamese neural network to learn and model the relationship between the vibrational signals and audio signals, represent that relationship alongside the vibrational signals and audio signals as a joint signal, and alert a user to the presence of a loose or malfunctioning part if an anomaly is detected within any of the three signals.

The vibration signals and acoustic signals may be any signals measured by sensors produced by or corresponding with the operation of a machine. For example, the vibrations caused by the spinning of a fan, and the sound created by the rotors of the fan agitating the air. In some embodiments, the signals may have one or more sources; for example, the sound signal of a fan may represent the combined sounds of the whine of the fan's motor, the squeak of the fan's axles and linkages, and the whir of the fan blades. Vibration signals may be also be herein referred to as vibration or vibrations, and acoustic signals may be herein referred to as sounds or sound signals. To the extent that sound is a subset of vibration, sound and vibration as respectively referred to herein are distinct from each other in that sounds are mechanical waves propagated through fluids such as air or water, and vibrations are mechanical waves propagated through solids such as steel or wood.

In some embodiments, the signals may include sounds or vibrations that are not produced by or corresponding with the operation of the machine, but are measurable within the environment of the machine. In some embodiments, the system may use signal isolation techniques to reduce or minimize interference from outside sources; for example, where the system is provided with the ranges of frequencies of sound and vibration known to be generated by the machine, the system may filter the sound and vibration by frequency range to remove sounds and vibrations outside of the ranges that the machine is known to produce by a particular margin, thereby filtering out background noises. The margin may be a range of frequencies of sound and vibration beyond that which the machine is known to produce, and may be sized to balance the objective of capturing anomalous acoustic and vibration signals falling outside the regular operational ranges of the machine against the objective of excluding acoustic and vibrational signals that are not produced by the machine.

In some embodiments of the invention, the vibration signals and acoustic signals may be continuously recorded for every time unit, where the time unit may be a discrete and consistent interval of time such as a second, two seconds, a minute, an hour, et cetera. In some embodiments, the signals may not be measured at regular intervals, such that each measurement of the signal occurs at inconsistent intervals; in such embodiments, acoustic signals and vibration signals may be recorded at the same or substantially the same intervals, so as to correspond with each other. In some embodiments, the time unit or interval at which the signals are measured may change based on external factors, such as in response to the machine being switched on or off, time of day, intensity of the machine's usage, age or wear or operational condition of the machine, et cetera. For example, in cases where parts may become loose or malfunction may occur quickly, or where failure to detect loose or malfunctioning parts may have particularly expensive or damaging consequences, the time interval may be smaller. In cases, for instance, where parts may take a longer time to become loose, malfunction carries lesser consequences, or computing power isn't available or economical for frequent measurements, the interval may be larger.

The embedding space, as referred to herein, may be a logical space within a machine learning model, such as a neural network, comprising low-dimensional, learned continuous vector representations of discrete variables. As such, the embedding space may be where signals from the sensors, as well as joint signals output by the machine learning model, are continuously converted into and represented as vectors, such that the vector is representative of all signals measured over the course of the operation of the system. The signals may additionally be represented as clusters within the embedding space.

In some embodiments of the invention, the joint signals may be a representation of the relationship between the acoustic signals and the vibration signals. Sounds and vibrations of a machine are different measurements, and so often cannot be directly compared. However, sounds and vibrations often correspond with each other. For example, during the operation of an oscillating fan, the electric motor produces a whining sound, and drives mechanical linkages to rotate the fan blades, which causes vibration. However, even where the sound or vibrations produced by a machine remain within expected ranges, there may still be something amiss if the relationship between the sound and vibrations changes. For example, the system may detect the sound of metal hitting metal, and could detect the vibration of screws; either of those signals independently are not indicative of a problem, but if they are occurring in the same place, and are therefore originating from the same part, that is indicative of a problem in the form of a loose screw, and can only be detected as a problem by identifying a relationship between the acoustic signals and the vibration signals. As such, by quantifying the relationship between sounds and vibrations output by a machine, the system may identify potential loose or malfunctioning components in scenarios where vibration signals and acoustic signals are individually nominal but where the relationship between them has changed.

In some embodiments, the joint signals may be the output of a Siamese neural network. A Siamese neural network may be a machine learning algorithm, specifically a neural network, that comprises two or more identical subnetworks; each subnetwork has the same configuration, with the same parameters and weights. The Siamese network is suited to learning embeddings that place the same classes or concepts close together, and can find the similarity of inputs by comparing their vectors. The Siamese network may compare input vectors using a contrastive loss function, which is a loss function that learns embeddings in which two similar points have a low Euclidean distance and two dissimilar points have a large Euclidean distance. Accordingly, where the Siamese network comprises two subnetworks, one of which has been provided an acoustic vector as input and the other of which has been provided a vibration vector as input, the output will be a vector comprising joint signals each time unit, where each joint signal is the Euclidean distance between the vibration signal and the acoustic signal at that time unit. The Euclidean distance enumerates the similarity between the acoustic signal and the vibration signal. In some embodiments of the invention, the Siamese network may accept acoustic vectors and vibration vectors as inputs from their respective embedding spaces; in some embodiments, the Siamese network may accept acoustic signals and vibration signals as they are measured and combine them into their respective vectors within the joint embedding space, and use the resulting vectors as inputs. In embodiments of the invention, other loss functions may be employed, such as the triplet loss function, and joint signals may be expressed by a variety of distance techniques, such as Manhattan distance.

In some embodiments of the invention, the system may cluster the signals as represented by vectors within their respective embedding spaces. The clustering may be performed using clustering techniques such as the k-means function or density-based spatial clustering of applications with noise (DBSCAN), which group measured signals such that measured signals in the same group are more similar to each other than to measured signals in other groups, forming clusters. Since the vibration signals and acoustic signals produced by a machine repeat for similar actions or conditions, the clustering process may produce clusters of signals with high coherency. In other words, the system may produce some number of discrete and identifiable clusters each corresponding to different contexts of the machine's operation. Contexts may be events, operational or environmental conditions, parameters, et cetera affecting the vibration and/or acoustic output of a machine. Contexts may include factors such as, for example, the temperature of the machine, age, wear or state of maintenance of the machine, operation of a replaced, repaired or modified component of the machine, operation of the machine at different settings or speeds, different materials used in the machine, medium within which the machine is immersed, et cetera. The context may be a single condition or event, such as operation of the machine at high temperature, or some number or combination of factors, such as operation of the machine at high temperature at its lowest speed setting. When operating within these contexts, the machine may produce distinctive sounds and/or vibrations, such that clustering the acoustic signals or vibration signals measured while the machine was being operated under that context produces a discrete cluster. The system may label or tag all clusters with metadata indicating the context to which the cluster corresponds.

In some embodiments of the invention, the system may extract profiles from the clusters. A profile may be a group of vibration, acoustic, and/or joint signals measured within a contiguous and finitely bounded segment of time which represents the nominal operation of the machine under a specific context, and which may be used as a baseline to compare future measurements against in order to identify outliers. Signals measured under the same or substantially similar contexts deviating from the profiles by a threshold amount may be indicative of anomalous or abnormal operation of the machine, and may indicate the presence of a loose or malfunctioning component. In some embodiments, for example where the system used k-means or DBSCAN to cluster the signals, the system may identify and extract profiles from the top-K clusters, which may be the most probable clusters; in other words, the top-K clusters may be the clusters that are most likely to accurately indicate the nominal operational profiles of the machine in a particular context. In some embodiments of the invention, the system may extract error profiles from one or more clusters where the context corresponding with the clusters involves a loose or malfunctioning component of the machine; in such an embodiment, an error profile may be a group of vibration, acoustic, and/or joint signals measured within a contiguous and finitely bounded segment of time which represents the operation of the machine when a particular component is loose or malfunctioning in a particular way. The system may prompt a human user to provide or verify contextual information for the error profile, such as the afflicted component and the particular malfunction. In some embodiments, the system may prompt a user for feedback regarding context when an outlier is detected, and may store the provided contextual information with the clustered signal data corresponding to the signal type of the outlier as an error profile.

In some embodiments of the invention, the system may determine the presence of an outlier when one or more new signals deviate from corresponding clusters in the profiles and/or in the embedding layers by an amount exceeding a threshold, where the threshold represents the magnitude of a deviation before an outlier can be considered indicative of a loose or malfunctioning part. Each of the signal types (acoustic, vibration, joint) may have a separate threshold representing magnitude of deviation before an outlier of that signal type can be considered indicative of a loose or functioning part, to account for the differing values of the different signal types. New signals may be any number or combination of new, recently, or most recently measured or determined acoustic signals, vibration signals, and/or joint signals. The threshold value may be pre-supplied by a human user or a software agent, and/or may be adjusted based on human feedback, historical data, need for accuracy versus sensitivity, et cetera. Additionally or alternatively, the system may compare the clustered data in an embedding layer of a given signal type against the error profiles of the corresponding signal type (acoustic, vibration, joint); if the similarity between the clustered data and one or more of the error profiles exceeds a certain threshold, the system may identify the presence of an outlier. In some embodiments, the system may compare the clustered data and the error profiles at regular intervals, which may or may not correspond with time units. In some embodiments, the system may determine the presence of an outlier by any other measure of a signal's deviation from the clusters, such as deviation from the average value of the clusters, and/or based on a measure of cosine similarity or similarity as determined by any other such similarity functions.

In some embodiments of the invention, the system may perform one or more ameliorative action when one or more outliers are detected. The ameliorative action may be triggered when one outlier is detected, or when some number of outliers is detected. For example, an ameliorative action may only be triggered when three or more outliers are detected within signals of a given type. An ameliorative action may be an action intended to ameliorate or address the impact of a loose or malfunctioning part. Ameliorative actions may include notifying a human user of the potential presence of a loose or malfunctioning part, and/or conveying information and/or soliciting feedback regarding the potential presence of the loose or malfunctioning part, et cetera. In some embodiments, for instance where the system has identified the clustered data as being sufficiently similar to an error profile, the system may inform the user of the potential source of the outlier based on the context corresponding with the error profile. The system may communicate with the user via text and/or graphical elements on the user's mobile device or computing device, vibrations on the user's wearable device, flashing lights, sounds or synthetic/recorded speech played from speakers, et cetera. In some embodiments, such as where the system is integrated, in communication with, or otherwise exercises some amount of control over the machine, the system may stop or slow down the machine, shut down malfunctioning or suspected to be malfunctioning components of the machine, et cetera.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to utilize a siamese neural network to model the relationship between acoustic signals and vibrational signals produced by a machine as joint signals, and identify faults via outliers from the acoustic signals, vibrational signals, and joint signals.

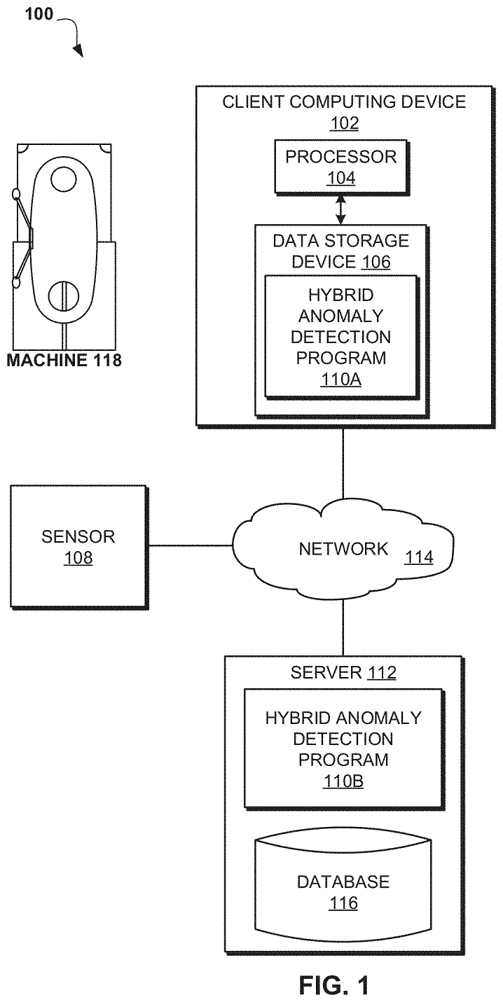

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102, sensors 108, machines 118, and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

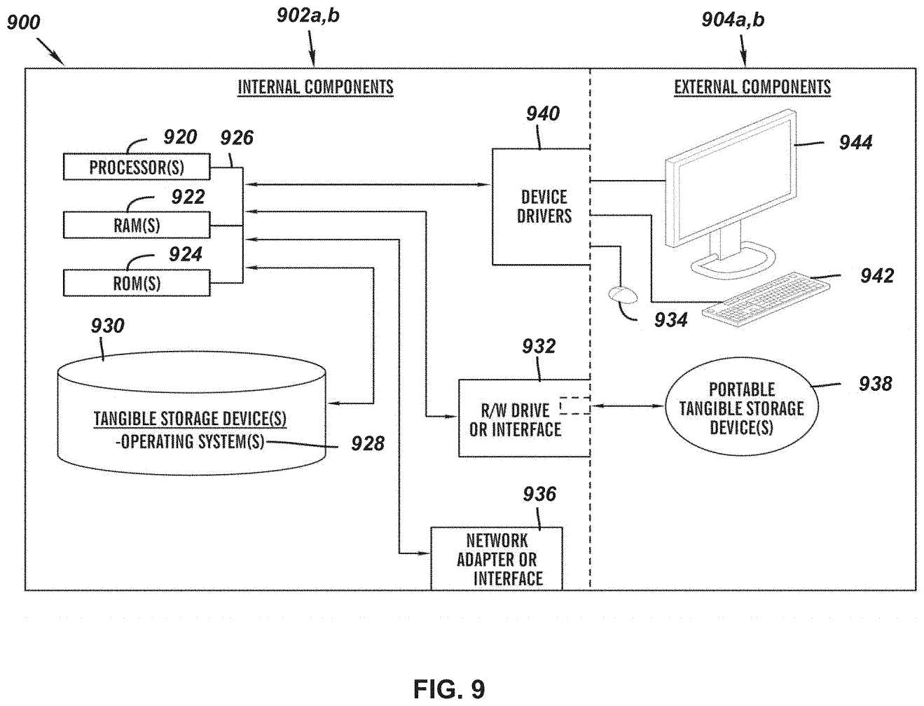

Client computing device 102 may include a processor 104 and a data storage device 106 that is enabled to host and run a hybrid anomaly detection program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 9, the client computing device 102 may include internal components 902a and external components 904a, respectively.

The server computer 112 may be a laptop computer, netbook computer, personal computer (PC), a desktop computer, or any programmable electronic device or any network of programmable electronic devices capable of hosting and running a hybrid anomaly detection program 110B and a database 116 and communicating with the client computing device 102 via the communication network 114, in accordance with embodiments of the invention. As will be discussed with reference to FIG. 9, the server computer 112 may include internal components 902b and external components 904b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

Sensor 108 may be any sensor capable of measuring vibration signals or acoustic signals produced by machine 118, and communicating measurements to hybrid anomaly detection program 110A, 110B, for instance via network 114, either directly or via some number of proxies or intermediary programs or devices. Sensor 108 may be, for example, an accelerometer, strain gauge, velocity sensor, microphone, eddy current or capacitive displacement sensor, vibration meter, et cetera. Sensor 108 may represent any number or combination of sensors, and may be deployed disposed against a surface of machine 118 or geographically proximate to machine 118 such that vibrations and/or sounds produced by machine 118 can propagate through the intervening medium between sensor 108 and machine 118 and remain measurable by sensor 108. In embodiments of the invention, sensors 108 may comprise at least one sensor for measuring vibration signals, and at least one sensor for measuring sound signals, where a vibration sensor measures mechanical waves propagating through a solid medium and a sound sensor measures mechanical waves propagating through a fluid such as air or water.

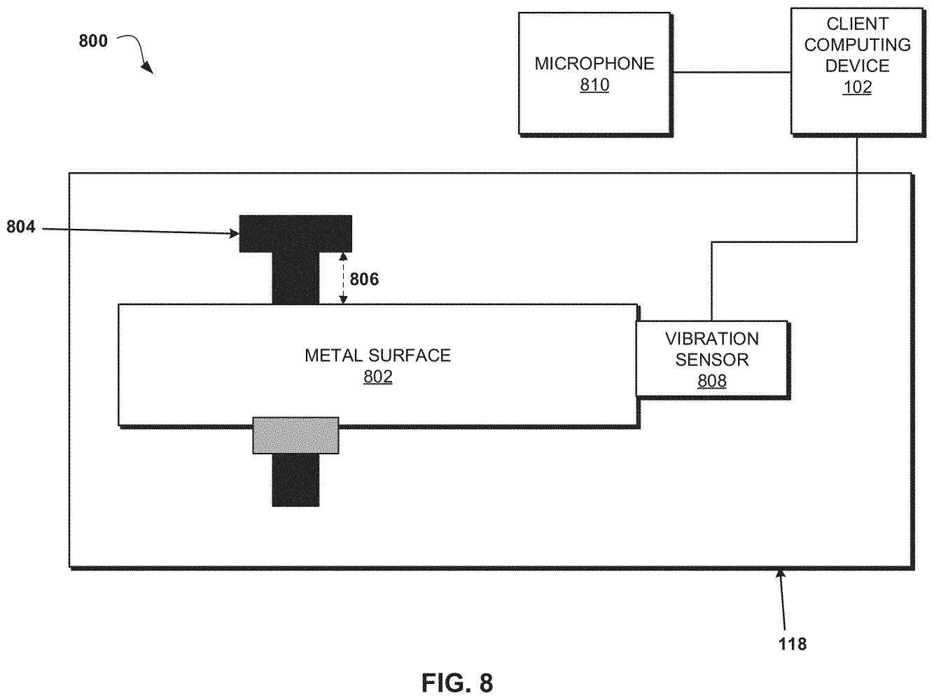

Machine 118 may be any mechanical and/or electrical device comprising moving parts, such that the device might produce measurable vibration or acoustic signals during operation which may be recorded by vibration and/or acoustic sensors 108. Machine 118 may be located on land or underwater. Machine 118 may, for example, be an aerial, terrestrial, or nautical drone, a piece of factory equipment such as an electrical generator, triphammer, drill press, radial saw, et cetera, a vehicle such as a car, plane, submarine, bicycle, skateboard, et cetera, a portable device such as a power tool, watch, laptop, et cetera, and so on. In some embodiments, machine 118 may be a device as a whole, for example a quadcopter drone, or may be a component or sub-device comprising the device, for example one of the four rotors of the drone. An exemplary hardware environment 800 illustrating machine 118 and sensors 108 is explained in greater detail below with respect to FIG. 8.

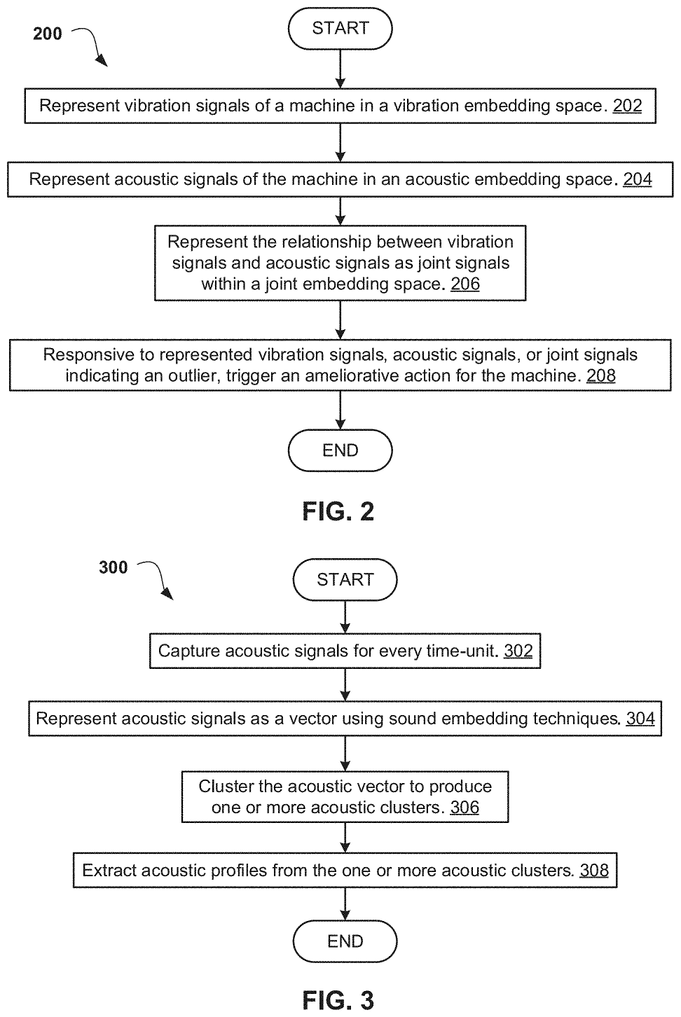

According to the present embodiment, the hybrid anomaly detection program 110A, 110B may be a program enabled to utilize a siamese neural network to model the relationship between acoustic signals and vibrational signals produced by a machine as joint signals, and identify faults via outliers from the acoustic signals, vibrational signals, and joint signals. The hybrid anomaly detection may be located on client computing device 102 or server 112 or on any other device located within network 114. Furthermore, hybrid anomaly detection may be distributed in its operation over multiple devices, such as client computing device 102 and server 112. The hybrid anomaly detection method is explained in further detail below with respect to FIG. 2.

Referring now to FIG. 2, an operational flowchart illustrating a hybrid anomaly detection process 200 is depicted according to at least one embodiment. At 202, the hybrid anomaly detection program 110A, 110B represents vibration signals of a machine in a vibration embedding space. The vibration signals may be any vibration signals measured by hybrid anomaly detection program 110A, 110B using sensors 108, or may be received from an external source, and may be recorded for each time unit during the operation of hybrid anomaly detection program 110A, 110B or some subset of time units. The hybrid anomaly detection program 110A, 110B may represent the vibration signals in the vibration embedding space by converting the vibration signals into one or more vectors, and may continuously add vibration signals onto the vector as they are measured. The hybrid anomaly detection program 110A, 110B may employ a neural network to convert the vibration signals into a vector, and may be represent the vector in the embedding space of the neural network. In some embodiments, the hybrid anomaly detection program 110A, 110B may alternatively or additionally represent the vibration signals as vibration clusters within the vibration embedding space. The hybrid anomaly detection program 110A, 110B may use clustering techniques to partition the vibration signals or vectors into one or more vibration clusters, where the vibration clusters are groupings of similar vibration signals organized around a central point. The hybrid anomaly detection program 110A, 110B may perform the clustering process using clustering techniques such as the k-means function or density-based spatial clustering of applications with noise (DBSCAN), which clusters similar signals together based on a range of metrics.

At 204, the hybrid anomaly detection program 110A, 110B represents acoustic signals of the machine in an acoustic embedding space. The acoustic signals may be any acoustic signals measured by hybrid anomaly detection program 110A, 110B using sensors 108, or may be received from an external source, and may be recorded for each time unit during the operation of hybrid anomaly detection program 110A, 110B or some subset of time units. The hybrid anomaly detection program 110A, 110B may represent the acoustic signals in the acoustic embedding space by converting the acoustic signals into a vector, and may continuously add acoustic signals onto the vector as they are measured. The hybrid anomaly detection program 110A, 110B may employ a neural network to convert the acoustic signals into a vector, and may be represent the vector in the embedding space of the neural network. In some embodiments, the hybrid anomaly detection program 110A, 110B may alternatively or additionally represent the acoustic signals as clusters within the acoustic embedding space. The hybrid anomaly detection program 110A, 110B may use clustering techniques to partition the acoustic signals or vectors into one or more acoustic clusters, where the acoustic clusters are groupings of similar acoustic signals organized around a central point. The hybrid anomaly detection program 110A, 110B may perform the clustering process using clustering techniques such as the k-means function or density-based spatial clustering of applications with noise (DBSCAN), which clusters similar signals together based on a range of metrics.

At 206, the hybrid anomaly detection program 110A, 110B represents the relationship between vibration signals and acoustic signals as joint signals within a joint embedding space. A joint signal may be an output by a Siamese network which enumerates the relationship between an acoustic signal and a vibration signal at a given time unit according to a similarity function such as a contrastive loss function or triplet loss function. The relationship between an acoustic signal and a vibration signal may be the similarity between an acoustic signal and a vibration signal at a given time unit, and may be expressed in a variety of ways. For instance, the relationship may be expressed as the Euclidean distance or Manhattan distance between the vibration signal and the acoustic signal. The hybrid anomaly detection program 110A, 110B may output a joint signal corresponding to every time unit occurring during the operation of hybrid anomaly detection program 110A, 110B. The hybrid anomaly detection program 110A, 110B may represent the joint signals in the joint embedding space by converting the joint signals into a vector, and may continuously add joint signals onto the vector as they are output by the Siamese network. In some embodiments, the hybrid anomaly detection program 110A, 110B may alternatively or additionally represent the joint signals or joint vectors as clusters within the joint embedding space. The hybrid anomaly detection program 110A, 110B may use clustering techniques to partition the joint signals or vectors into one or more joint clusters, where the joint clusters are groupings of similar joint signals organized around a central point. The hybrid anomaly detection program 110A, 110B may perform the clustering process using clustering techniques such as the k-means function or density-based spatial clustering of applications with noise (DBSCAN), which clusters similar signals together based on a range of metrics.

At 208, the hybrid anomaly detection program 110A, 110B, responsive to represented vibration signals, acoustic signals, or joint signals indicating an outlier, triggers an ameliorative action for the machine. The hybrid anomaly detection program 110A, 110B may determine the presence of an outlier when one or more measured signals, including vibration signals, acoustic signals, and joint signals, deviate from the signals, vectors, or clusters generated during the operation of hybrid anomaly detection program 110A, 110B, or from representative clusters in the profiles, by an amount exceeding a threshold, where the threshold represents the magnitude of a deviation before a signal can be considered indicative of a loose or malfunctioning part, and therefore considered to be an outlier. Additionally or alternatively, the hybrid anomaly detection program 110A, 110B may compare the clustered data in an embedding layer of a given signal type against the error profiles of the corresponding signal type (acoustic, vibration, joint); if the similarity between the clustered data and one or more of the error profiles exceeds a certain threshold, the hybrid anomaly detection program 110A, 110B may identify the presence of an outlier. In some embodiments of the invention, hybrid anomaly detection program 110A, 110B may compare clustered signal data against the error profiles of the corresponding type after an outlier has been detected, for the purpose of identifying the context of the outlier and providing additional information to the human user.

The hybrid anomaly detection program 110A, 110B may trigger one or more ameliorative actions when one or more outliers are detected. The ameliorative action may be an action intended to ameliorate or address the impact of a loose or malfunctioning part. Ameliorative actions may include notifying a human user of the potential presence of a loose or malfunctioning part, and/or conveying information and/or soliciting feedback regarding the potential presence of the loose or malfunctioning part, et cetera. In some embodiments, for instance where the hybrid anomaly detection program 110A, 110B has identified the clustered data as being sufficiently similar to an error profile, the hybrid anomaly detection program 110A, 110B may inform the user of the potential source of the outlier based on the context corresponding with the error profile. The hybrid anomaly detection program 110A, 110B may communicate with the user via text and/or graphical elements on the user's mobile device or computing device, vibrations on the user's wearable device, flashing lights, sounds or synthetic/recorded speech played from speakers, et cetera. In some embodiments, such as where the hybrid anomaly detection program 110A, 110B is integrated, in communication with, or otherwise exercises some amount of control over the machine, the hybrid anomaly detection program 110A, 110B may stop or slow down the machine, shut down malfunctioning or suspected to be malfunctioning components of the machine, et cetera.

Referring now to FIG. 3, an operational flowchart illustrating a baseline acoustic profile modelling process 300 is depicted according to at least one embodiment. At 302, hybrid anomaly detection program 110A, 110B captures acoustic signals for every time unit. The hybrid anomaly detection program 110A, 110B measures, through sensor 108, an acoustic signal at every time unit to produce a time-series of measurements corresponding to the acoustic signals produced by the machine.

At 304, hybrid anomaly detection program 110A, 110B represents acoustic signals as a vector or vectors using sound embedding techniques. The hybrid anomaly detection program 110A, 110B converts the time series of acoustic signals into a vector which represents each measurement at the time when it was recorded. The hybrid anomaly detection program 110A, 110B may employ a neural network to convert the acoustic signals into a vector, and may be represent the vector in the embedding space of the neural network.

At 306, the hybrid anomaly detection program 110A, 110B clusters the acoustic vector or vectors to produce one or more acoustic clusters. The hybrid anomaly detection program 110A, 110B may partition the acoustic signals represented by the acoustic vector in the acoustic embedding spaces into one or more acoustic clusters, where the acoustic clusters are groupings of similar acoustic signals organized around a central point. The hybrid anomaly detection program 110A, 110B may perform the clustering process using clustering techniques such as the k-means function or density-based spatial clustering of applications with noise (DBSCAN), which clusters similar signals together based on a range of metrics. The hybrid anomaly detection program 110A, 110B may detect the top-K clusters of the acoustic clusters, where the top-K clusters are a subset of the acoustic clusters which score highest in one of a number of metrics such as confidence score, coherency, et cetera.

At 308, hybrid anomaly detection program 110A, 110B extracts acoustic profiles from the one or more acoustic clusters. Since the acoustic signals produced by a machine repeat for similar actions or conditions, the clustering process may produce clusters of acoustic signals with high coherency. In other words, the hybrid anomaly detection program 110A, 110B may produce clearly delineated clusters each corresponding to individual contexts affecting the acoustic output of a machine. The hybrid anomaly detection program 110A, 110B may extract, or record, the acoustic clusters as acoustic profiles to use as a baseline; outliers that fall outside of a acoustic profile by a threshold amount may be considered anomalous, or indicative of the presence of a loose or malfunctioning component, and labeled as outliers. In some embodiments, the hybrid anomaly detection program 110A, 110B may select a subset of the acoustic clusters to extract as acoustic profiles; the subset of acoustic clusters may be acoustic clusters that are particularly well suited to represent the acoustic signals produced by the machine in particular contexts, and may be selected based on accuracy, coherency, confidence, et cetera. For example, where acoustic clusters are created using the K-means clustering technique, the hybrid anomaly detection program 110A, 110B may select the top-K acoustic clusters to extract as acoustic profiles.

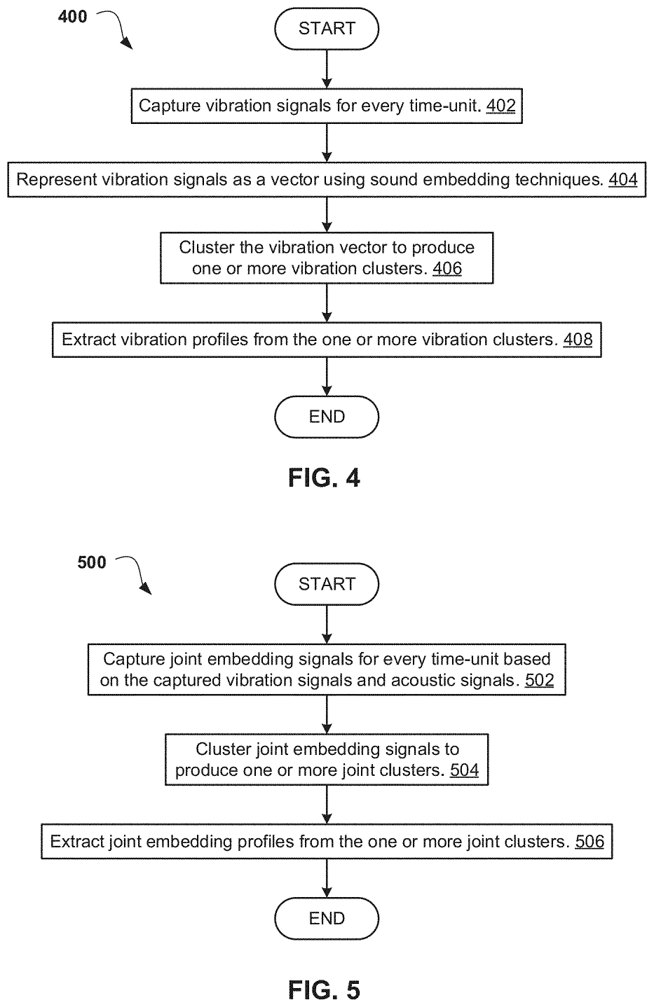

Referring now to FIG. 4, an operational flowchart illustrating a baseline vibration profile modelling process 400 is depicted according to at least one embodiment. At 402, hybrid anomaly detection program 110A, 110B captures vibration signals for every time unit. The hybrid anomaly detection program 110A, 110B measures, through sensor 108, a vibration signal at every time unit to produce a time-series of measurements corresponding to the vibration signals produced by the machine.

At 404, hybrid anomaly detection program 110A, 110B represents vibration signals as a vector using sound embedding techniques. The hybrid anomaly detection program 110A, 110B converts the time series of vibration signals into one or more vectors which represent each measurement at the time when it was recorded. The hybrid anomaly detection program 110A, 110B may employ a neural network to convert the vibration signals into a vector, and may be represent the vector in the embedding space of the neural network.

At 406, the hybrid anomaly detection program 110A, 110B clusters the vibration vector to produce one or more vibration clusters. The hybrid anomaly detection program 110A, 110B may partition the vibration signals represented by the vector in the vibration embedding spaces into one or more vibration clusters, where the vibration clusters are groupings of similar vibration signals organized around a central point. The hybrid anomaly detection program 110A, 110B may perform the clustering process using clustering techniques such as the k-means function or density-based spatial clustering of applications with noise (DBSCAN), which clusters similar signals together based on a range of metrics. The hybrid anomaly detection program 110A, 110B may detect the top-K clusters of the vibration clusters, where the top-K clusters are a subset of the vibration clusters which score highest in one of a number of metrics such as confidence score, coherency, et cetera.

At 408, hybrid anomaly detection program 110A, 110B extracts vibration profiles from the one or more vibration clusters. Since the vibration signals produced by a machine repeat for similar actions or conditions, the clustering process may produce clusters of vibration signals with high coherency. In other words, the hybrid anomaly detection program 110A, 110B may produce clearly delineated clusters each corresponding to individual contexts affecting the vibration output of a machine. The hybrid anomaly detection program 110A, 110B may extract, or record, the clusters as vibration profiles to use as a baseline; outliers that fall outside of a vibration profile by a threshold amount may be considered anomalous, or indicative of the presence of a loose or malfunctioning component, and labeled as outliers. In some embodiments, the hybrid anomaly detection program 110A, 110B may select a subset of the vibration clusters to extract as vibration profiles; the subset of vibration clusters may be vibration clusters that are particularly well suited to represent the vibration signals produced by the machine in particular contexts, and may be selected based on accuracy, coherency, confidence, et cetera. For example, where vibration clusters are created using the K-means clustering technique, the hybrid anomaly detection program 110A, 110B may select the top-K vibration clusters to extract as vibration profiles.

Referring now to FIG. 5, an operational flowchart illustrating a baseline joint acoustic and vibration profile modelling process 500 is depicted according to at least one embodiment. At 502, hybrid anomaly detection program 110A, 110B captures joint embedding signals, also referred to herein as joint signals, for every time unit based on the captured vibration signals and acoustic signals. The Siamese network may output a joint signal for each time unit during the operation of hybrid anomaly detection program 110A, 110B, wherein the joint signal represents a relationship between a vibration signal and an acoustic signal both measured at or substantially at the same time unit; the hybrid anomaly detection program 110A, 110B thereby creates a time series of joint signals. In some embodiments of the invention, hybrid anomaly detection program 110A, 110B may represent the joint signals as a vector using sound embedding techniques. The hybrid anomaly detection program 110A, 110B converts the time series of joint signals into a vector which represents each joint signal at the time when the acoustic signal and vibration signal comprising the joint signal were recorded. The hybrid anomaly detection program 110A, 110B may employ a neural network to convert the joint signals into a vector or vectors, and may represent the vector or vectors in an embedding space of the neural network.

At 504, the hybrid anomaly detection program 110A, 110B clusters the joint embedding signals, and/or the joint vector, to produce one or more joint clusters. The hybrid anomaly detection program 110A, 110B may partition the joint signals, or the vector representing the joint signals, in the joint embedding space into one or more joint clusters, where the joint clusters are discrete groupings of similar joint signals organized around a central point. The clustering may be performed using clustering techniques such as the k-means function or density-based spatial clustering of applications with noise (DBSCAN), which group similar signals together based on a range of metrics. The hybrid anomaly detection program 110A, 110B may detect the top-K clusters of the joint clusters, where the top-K clusters are a subset of the joint clusters which score highest in one of a number of metrics such as confidence score, coherency, et cetera.

At 506, hybrid anomaly detection program 110A, 110B extracts joint embedding profiles, or joint profiles, from the one or more clusters. Since the acoustic signals and vibration signals produced by a machine individually repeat for similar actions or conditions, the joint signals representing the relationships between the two signals likewise repeat for similar actions or conditions. As such, the clustering process may produce clusters of joint signals with high coherency. In other words, the hybrid anomaly detection program 110A, 110B may produce clearly delineated joint clusters each corresponding to individual contexts affecting the relationship between the acoustic and vibrational output of a machine. The hybrid anomaly detection program 110A, 110B may extract, or record, the clusters as joint profiles to use as a baseline; joint signals that fall outside of a the clusters represented within the joint profile by a threshold amount may be considered anomalous, or indicative of the presence of a loose or malfunctioning component, and labeled as outliers. In some embodiments, the hybrid anomaly detection program 110A, 110B may select a subset of the clusters to extract as profiles; the subset of clusters may be clusters that are particularly well suited to represent the joint signals produced by the machine in particular contexts, and may be selected based on accuracy, coherency, confidence, et cetera. For example, where joint clusters are created using the K-means clustering technique, the hybrid anomaly detection program 110A, 110B may select the top-K joint clusters to extract as joint profiles.

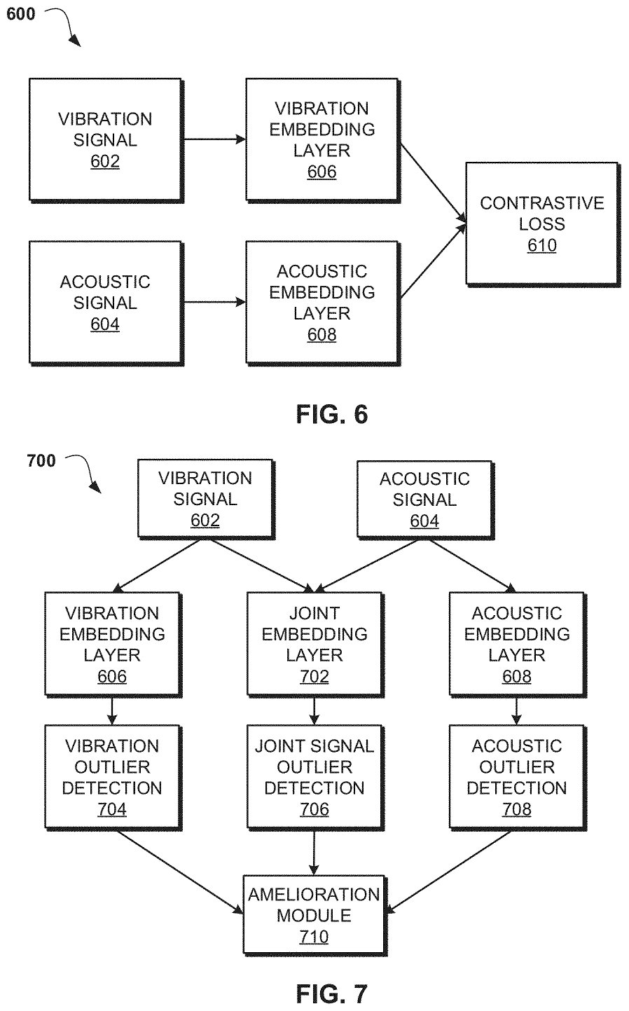

Referring now to FIG. 6, a method 600 of learning a joint embedding between acoustic and vibration embeddings is depicted according to at least one embodiment. Here, hybrid anomaly detection program 110A, 110B provides vibration signal 602 to vibration embedding layer 606, which is an embedding layer of a neural network where vibration signal 602 is converted into and represented as a vector. Meanwhile, hybrid anomaly detection program 110A, 110B provides acoustic signal 604 as input to acoustic embedding layer 608, which is an embedding layer of a neural network where acoustic signal 604 is converted into and represented as a vector; the output of the vibration embedding layer 606, specifically a vibration vector representing vibration signal 602, and the output of the acoustic embedding layer 608, specifically an acoustic vector representing acoustic signal 604, are input to the contrastive loss layer 610. The contrastive loss layer 610 may be a layer of a neural network such as a Siamese network implementing a contrastive loss function, where the contrastive loss function accepts the vibration vector and the acoustic vector as inputs and quantifies the similarity between each vibration signal and acoustic signal for every time unit within the respective vectors, which the contrastive loss function provides as an output.

Referring now to FIG. 7, an operational flowchart illustrating an implementation 700 of a hybrid anomaly detection process is depicted according to at least one embodiment. Here, hybrid anomaly detection program 110A, 110B provides vibration signal 602 as inputs to vibration embedding layer 606 and joint embedding layer 702. The hybrid anomaly detection program 110A, 110B likewise provides acoustic signal 604 as inputs to joint embedding layer 702 and acoustic embedding layer 608. Vibration embedding layer 606 may provide a vibration vector representing vibration signal 602 to vibration outlier detection 704. Joint embedding layer 702 may provide a joint vector representing a joint signal as input to joint signal outlier detection 706, and acoustic embedding layer 608 may provide an acoustic vector representing acoustic signal 604 to acoustic outlier detection 708.

Vibration outlier detection 704 may represent the vibration vector as vibration clusters utilizing clustering techniques such as k-means function or DBSCAN, and may monitor the clusters for outliers. In some embodiments, vibration outlier detection 704 may compare the clusters against vibration profiles. When a vibration signal deviates from the cluster and/or from the vibration profile by an amount exceeding a threshold, vibration outlier detection 704 may output a signal to amelioration module 710 reporting the outlier as an anomaly that may indicate the presence of a potential loose or malfunctioning part. In some embodiments, vibration outlier detection 704 compares the vibration clusters against vibration error profiles, and if the vibration clusters and the vibration error profiles exceed a threshold of similarity, vibration outlier detection 704 may output a signal to amelioration module 710 reporting an outlier.

Likewise, joint signal outlier detection 706 may represent the joint vector as joint clusters, and may monitor the joint clusters for outliers. In some embodiments, joint outlier detection 706 may compare the clusters against joint profiles. When a joint signal deviates from the cluster and/or from the joint profile by an amount exceeding a threshold, joint outlier detection 706 may output a signal to amelioration module 710 reporting the outlier as an anomaly that may indicate the presence of a potential loose or malfunctioning part. In some embodiments, joint signal outlier detection 706 compares the joint signal clusters against joint error profiles, and if the joint signal clusters and the joint error profiles exceed a threshold of similarity, joint signal outlier detection 706 may output a signal to amelioration module 710 reporting an outlier.

Acoustic outlier detection 708 may represent the acoustic vector as acoustic clusters and may monitor the clusters for outliers. In some embodiments, acoustic outlier detection 708 may compare the clusters against acoustic profiles. When an acoustic signal deviates from the cluster and/or from the acoustic profile by an amount exceeding a threshold, acoustic outlier detection 708 may output a signal to amelioration module 710 reporting the outlier as an anomaly that may indicate the presence of a potential loose or malfunctioning part. In some embodiments, acoustic outlier detection 708 compares the acoustic clusters against acoustic error profiles, and if the acoustic clusters and the acoustic error profiles exceed a threshold of similarity, acoustic outlier detection 708 may output a signal to amelioration module 710 reporting an outlier.

Amelioration module 710 may perform ameliorative actions based on outliers received from vibration outlier detection 704, joint signal outlier detection 706, and acoustic outlier detection 708. In some embodiments, amelioration module 710 may perform one or more ameliorative actions based on a report of an outlier from any one of the three outlier detection modules 704, 706, 708; in some embodiments, amelioration module 710 may require a minimum number or combination of outliers from the three outlier detection modules 704, 706, 708 to trigger one or more ameliorative actions. Upon an ameliorative action being triggered, the amelioration module 710 may notify a human user of the potential presence of a loose or malfunctioning part, inform the human user of the location or nature of the loose or malfunctioning part, solicit feedback regarding the presence of and/or nature of the loose or malfunctioning part, et cetera. The amelioration module 710 may communicate with the user via text and/or graphical elements on the user's mobile device or computing device, vibrations on the user's wearable device, flashing lights, sounds or synthetic/recorded speech played from speakers, et cetera. In some embodiments, such as where the hybrid anomaly detection program 110A, 110B is integrated, in communication with, or otherwise exercises some amount of control over the machine, the amelioration module 710 may stop or slow down the machine, shut down malfunctioning or suspected to be malfunctioning components of the machine, et cetera.

Referring now to FIG. 8, a diagram illustrating an exemplary hardware environment 800 of an implementation of a hybrid anomaly detection process is depicted according to at least one embodiment. Here, machine 118 is depicted, comprising a metal surface 802 through which a bolt 804 has been threaded. Bolt 804 is coming loose from metal surface 802; rather than fitting snugly against metal surface 802, bolt 804 protrudes from metal surface 802 by a distance 806. Vibration sensor 808, which is a sensor 108 enabled to measure mechanical waves through a solid medium, is interfacing with metal surface 802 such that vibration sensor 808 can detect the vibrations propagated through metal surface 802 by bolt 804 sliding and impacting with metal surface 802. Microphone 810, which is a sensor 108 enabled to measure mechanical waves through a fluid, is disposed some distance away from machine 118, and can detect the sounds made by bolt 804 as it rattles and clangs against metal surface 102. Microphone 810 and vibration sensor 808 are connected to a client computing device 102, which is running hybrid anomaly detection program 110A.

It may be appreciated that FIGS. 2-8 provide only illustrations of individual implementations and do not imply any limitations with regard to how different embodiments may be implemented. Many modifications to the depicted environments may be made based on design and implementation requirements.

FIG. 9 is a block diagram 900 of internal and external components of the client computing device 102 and the server 112 depicted in FIG. 1 in accordance with an embodiment of the present invention. It should be appreciated that FIG. 9 provides only an illustration of one implementation and does not imply any limitations with regard to the environments in which different embodiments may be implemented. Many modifications to the depicted environments may be made based on design and implementation requirements.

The data processing system 902, 904 is representative of any electronic device capable of executing machine-readable program instructions. The data processing system 902, 904 may be representative of a smart phone, a computer system, PDA, or other electronic devices. Examples of computing systems, environments, and/or configurations that may represented by the data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 902 a,b and external components 904 a,b illustrated in FIG. 9. Each of the sets of internal components 902 include one or more processors 920, one or more computer-readable RAMs 922, and one or more computer-readable ROMs 924 on one or more buses 926, and one or more operating systems 928 and one or more computer-readable tangible storage devices 930. The one or more operating systems 928, the hybrid anomaly detection program 110A in the client computing device 102, and the hybrid anomaly detection program 110B in the server 112 are stored on one or more of the respective computer-readable tangible storage devices 930 for execution by one or more of the respective processors 920 via one or more of the respective RAMs 922 (which typically include cache memory). In the embodiment illustrated in FIG. 9, each of the computer-readable tangible storage devices 930 is a magnetic disk storage device of an internal hard drive. Alternatively, each of the computer-readable tangible storage devices 930 is a semiconductor storage device such as ROM 924, EPROM, flash memory or any other computer-readable tangible storage device that can store a computer program and digital information.

Each set of internal components 902 a,b also includes a R/W drive or interface 932 to read from and write to one or more portable computer-readable tangible storage devices 938 such as a CD-ROM, DVD, memory stick, magnetic tape, magnetic disk, optical disk or semiconductor storage device. A software program, such as the hybrid anomaly detection program 110A, 110B, can be stored on one or more of the respective portable computer-readable tangible storage devices 938, read via the respective R/W drive or interface 932, and loaded into the respective hard drive 930.

Each set of internal components 902 a,b also includes network adapters or interfaces 936 such as a TCP/IP adapter cards, wireless Wi-Fi interface cards, or 3G or 4G wireless interface cards or other wired or wireless communication links. The hybrid anomaly detection program 110A in the client computing device 102 and the hybrid anomaly detection program 110B in the server 112 can be downloaded to the client computing device 102 and the server 112 from an external computer via a network (for example, the Internet, a local area network or other, wide area network) and respective network adapters or interfaces 936. From the network adapters or interfaces 936, the hybrid anomaly detection program 110A in the client computing device 102 and the hybrid anomaly detection program 110B in the server 112 are loaded into the respective hard drive 930. The network may comprise copper wires, optical fibers, wireless transmission, routers, firewalls, switches, gateway computers and/or edge servers.

Each of the sets of external components 904 a,b can include a computer display monitor 944, a keyboard 942, and a computer mouse 934. External components 904 a,b can also include touch screens, virtual keyboards, touch pads, pointing devices, and other human interface devices. Each of the sets of internal components 902 a,b also includes device drivers 940 to interface to computer display monitor 944, keyboard 942, and computer mouse 934. The device drivers 940, R/W drive or interface 932, and network adapter or interface 936 comprise hardware and software (stored in storage device 930 and/or ROM 924).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

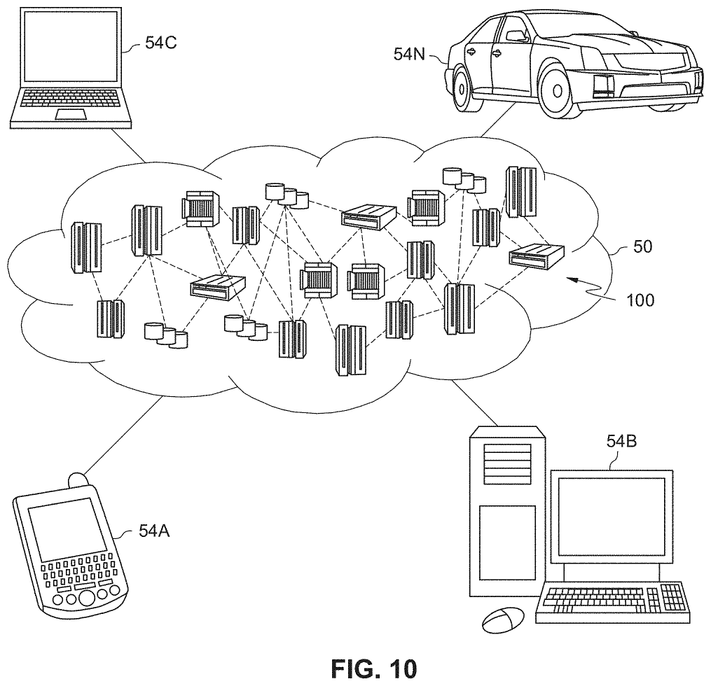

Referring now to FIG. 10, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 100 and cloud computing environment 50 can communicate with any type of computerized device over any type of network and/or network addressable connection (e.g., using a web browser).

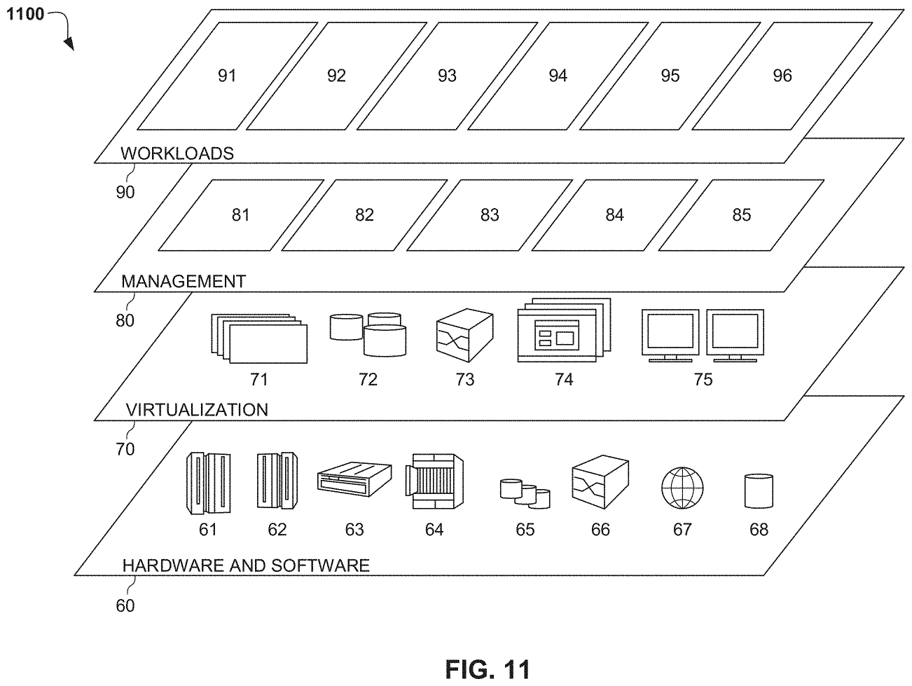

Referring now to FIG. 11, a set of functional abstraction layers 1100 provided by cloud computing environment 50 is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and hybrid anomaly detection 96. The hybrid anomaly detection 96 may be enabled to utilize a siamese neural network to model the relationship between acoustic signals and vibrational signals produced by a machine as joint signals, and identify faults via outliers from the acoustic signals, vibrational signals, and joint signals.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for detecting loose or malfunctioning components within a machine, the method comprising:
measuring, by one or more sensors, one or more vibration signals and one or more acoustic signals of the machine;
determining one or more joint signals, wherein the one or more joint signals comprise one or more relationships between the one or more vibration signals and the one or more acoustic signals; and
responsive to one or more new signals deviating from the one or more vibration signals, one or more acoustic signals, and/or one or more joint signals by an amount exceeding at least one threshold, triggering one or more ameliorative actions.

2. The method of claim 1, wherein the relationships between vibration signals and the acoustic signals comprise a similarity enumerated by a siamese neural network.

3. The method of claim 1, further comprising:
representing the acoustic signals as one or more acoustic clusters using one or more clustering techniques;
extracting one or more acoustic profiles from the one or more acoustic clusters.

4. The method of claim 1, further comprising:
representing the vibration signals as one or more vibration clusters using one or more clustering techniques;
extracting one or more vibration profiles from the one or more vibration clusters.

5. The method of claim 1, further comprising:
representing the joint signals as one or more joint clusters using one or more clustering techniques:
extracting one or more joint profiles from the one or more joint clusters.

6. The method of claim 1, further comprising:
responsive to one or more of the new signals deviating from a vibration profile, acoustic profile, and/or joint profile by an amount exceeding a threshold, triggering one or more ameliorative actions.

7. The method of claim 1, wherein the vibration signals are represented as one or more vibration clusters, the acoustic signals are represented as one or more acoustic clusters, and the joint signals are represented as one or more joint clusters, and one or more clusters selected from the one or more vibration clusters, the one or more acoustic clusters, and/or the one or more vibration clusters are tagged with metadata indicating one or more contexts to which the one or more clusters correspond.

8. A computer system for detecting loose or malfunctioning components within a machine, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
measuring, by one or more sensors, one or more vibration signals and one or more acoustic signals of the machine;
determining one or more joint signals, wherein the one or more joint signals comprise one or more relationships between the one or more vibration signals and the one or more acoustic signals; and
responsive to one or more new signals deviating from the one or more vibration signals, one or more acoustic signals, and/or one or more joint signals by an amount exceeding at least one threshold, triggering one or more ameliorative actions.

9. The computer system of claim 8, wherein the relationships between vibration signals and the acoustic signals comprise a similarity enumerated by a siamese neural network.

10. The computer system of claim 8, further comprising:
representing the acoustic signals as one or more acoustic clusters using one or more clustering techniques;
extracting one or more acoustic profiles from the one or more acoustic clusters.

11. The computer system of claim 8, further comprising:
representing the vibration signals as one or more vibration clusters using one or more clustering techniques;
extracting one or more vibration profiles from the one or more vibration clusters.

12. The computer system of claim 8, further comprising:
representing the joint signals as one or more joint clusters using one or more clustering techniques:
extracting one or more joint profiles from the one or more joint clusters.

13. The computer system of claim 8, further comprising:
responsive to one or more of the new signals deviating from a vibration profile, acoustic profile, and/or joint profile by an amount exceeding a threshold, triggering one or more ameliorative actions.

14. The computer system of claim 8, wherein the vibration signals are represented as one or more vibration clusters, the acoustic signals are represented as one or more acoustic clusters, and the joint signals are represented as one or more joint clusters, and one or more clusters selected from the one or more vibration clusters, the one or more acoustic clusters, and/or the one or more vibration clusters are tagged with metadata indicating one or more contexts to which the one or more clusters correspond.

15. A computer program product for detecting loose or malfunctioning components within a machine, the computer program product comprising:
one or more computer-readable tangible storage medium and program instructions stored on at least one of the one or more tangible storage medium, the program instructions executable by a processor to cause the processor to perform a method comprising:
measuring, by one or more sensors, one or more vibration signals and one or more acoustic signals of the machine;
determining one or more joint signals, wherein the one or more joint signals comprise one or more relationships between the one or more vibration signals and the one or more acoustic signals; and
responsive to one or more new signals deviating from the one or more vibration signals, one or more acoustic signals, and/or one or more joint signals by an amount exceeding at least one threshold, triggering one or more ameliorative actions.

16. The computer program product of claim 15, wherein the relationships between vibration signals and the acoustic signals comprise a similarity enumerated by a siamese neural network.

17. The computer program product of claim 15, further comprising:
representing the acoustic signals as one or more acoustic clusters using one or more clustering techniques;
extracting one or more acoustic profiles from the one or more acoustic clusters.

18. The computer program product of claim 15, further comprising:
representing the vibration signals as one or more vibration clusters using one or more clustering techniques;
extracting one or more vibration profiles from the one or more vibration clusters.

19. The computer program product of claim 15, further comprising:
representing the joint signals as one or more joint clusters using one or more clustering techniques:
extracting one or more joint profiles from the one or more joint clusters.

20. The computer program product of claim 15, further comprising:
responsive to one or more of the new signals deviating from a vibration profile, acoustic profile, and/or joint profile by an amount exceeding a threshold, triggering one or more ameliorative actions.
